(19) United States
(12) Patent Application Publication
(10) Pub. No.: US 2025/0150488 A1
(43) Pub. Date: May 8, 2025

(54) IDENTIFYING NETWORK-BASED ATTACKS ON PHYSICAL OPERATIONAL TECHNOLOGY (OT) DEVICES WITH DECOY OT DEVICES

(71) Applicant: Fortinet, Inc., Sunnyvale, CA (US)

(72) Inventors: Jun Jiang, Vancouver (CA); Hongquan Mi, Surry (CA); Moshe Ben Simon, Atlit (IL)

(73) Assignee: Fortinet, Inc., Sunnyvale, CA (US)

(21) Appl. No.: 18/217,148

(22) Filed: Jun. 30, 2023

(51) Int. Cl. H04L 9/40; H04L 41/16

(52) U.S. Cl. CPC H04L 63/1491; H04L 41/16; H04L 63/1425

(57) ABSTRACT

An Operational Technology (OT) device database is trained by interrogating physical OT devices over the data communication network, and from responses, generating a profile for each interrogated physical OT device, each profile comprising at least data used to set up decoy OT devices that are virtualized to mirror each interrogated physical OT device. A list of local physical OT devices running on a remote private network is received from a specific deception appliance on the remote private network. OT device profiles are selected from the OT device database based on the list of local physical OT devices. The selected OT device profiles are transmitted to the specific deception appliance, at the remote private network. The specific deception appliance maintains VM machines for running decoy OT devices, based on the selected OT device profiles, on the remote private network. Responsive to detecting data traffic destined for one of the decoy OT devices, the specific deception appliance takes a security action on a source related to the detected.

### FIELD OF THE INVENTION

The invention relates generally to computer networks, and more specifically, to identifying network-based attacks on physical OT devices with decoy OT devices.

### BACKGROUND

Currently, the deception network that runs decoys, mostly refers to honeypots, as a lure to protect devices from attackers. The decoy is usually categorized by different OS or different products, for instance, Windows decoy, Ubuntu decoy, Mac decoy, IP camera decoy, printer decoy, PLC decoy, etc. The goal is to run the honeypot assigned with an IP address and emulated services as a real asset that appeared in the network with high fidelity and high anti-reconnaissance capability.

From the IT technology perspective, OS development and upgrade take a while to release and popularize in the market, which is not a problem that the deception system updates the supported decoy after a reasonable time gap. However, in the Operation Technology (OT) market product upgrade and new module release to market is faster compared to the OS release frequency in the IT tech field. The attacker actively chases after the OT asset by seeking a specific product type or even a specific module to execute a targeted vulnerability attack. The current common OT-supported decoy service is required to regularly check the OT device identification spec and then built them into the decoy to emulate the specific vulnerable OT device services. The time gap between the vulnerability exposure and decoy release is usually big and such delay could cause the customer won't be able to deploy the OT decoy urgently to protect the OT assets unless waiting for the next release of the new supported decoy by the security service vendor.

On the other hand, the fingerprinting attack is the essential step for the attacker to identify the asset and avoid entering the honeypot lure. In the IT network, the common way is to use OS fingerprinting tool to send an active probe and identify the OS information by analyzing the packets, for example, TCP/IP SYN+SYN ACK as well as may include the ICMP packet. However, the asset identification step in the OT network includes two steps, which are fingerprinting at the OS level and the OT protocol level. By sending a specific asset identification request packet, which varies depending on different OT protocols, the attacker analyzed the response packet and inspects the asset identification and configuration to check whether it is a real OT device or a fake device that has emulated service (e.g conpot, gaspot, snap7) running there.

To tackle the issues described above, the decoy technology applied in the deception service is required to be able to equip the OT decoy with high-fidelity fingerprint, asset identification, configuration and behavior as vivid as a real OT device that can defeat the fingerprinting attack and to lure the attacker into the deception network.

What is needed is a robust technique for identifying network-based attacks on physical OT devices with decoy OT devices.

### SUMMARY

To meet the above-described needs, methods, computer program products, and systems in Operational Technology (OT)/Industrial Control System (ICS) environments for identifying network-based attacks on physical OT devices with decoy OT devices.

In one embodiment, an OT device database is trained by interrogating physical OT devices over the data communication network, and from responses, generating a profile for each interrogated physical OT device, each profile comprising at least data used to set up decoy OT devices that are virtualized to mirror each interrogated physical OT device.

In another embodiment, a list of local physical OT devices running on a remote private network is received from a specific deception appliance on the remote private network. OT device profiles are selected from the OT device database based on the list of local physical OT devices. In addition, other OT device profiles requested by user can be set up. The selected OT device profiles are transmitted to the specific deception appliance, at the remote private network.

In still another embodiment, the specific deception appliance maintains VM machines for running decoy OT devices, based on the selected OT device profiles, on the remote private network. Responsive to detecting data traffic destined for one of the decoy OT devices, the specific deception appliance takes a security action on a source related to the detected data.

Advantageously, computer networking is improved with more secure and efficient network traffic.

### BRIEF DESCRIPTION OF THE DRAWINGS

In the following drawings, like reference numbers are used to refer to like elements. Although the following figures depict various examples of the invention, the invention is not limited to the examples depicted in the figures.

FIG. 1 is a high-level block diagram illustrating a network system for identifying network-based attacks on physical OT devices with decoy OT devices, according to one embodiment.

FIG. 2A-2B is a more detailed block diagram illustrating a decoy appliance of the system of FIG. 1, according to one embodiment.

FIG. 3 is a block diagram illustrating an array of OT physical devices with attributes being interrogated, according to an embodiment.

FIG. 4 is a high-level flow chart for identifying network-based attacks on physical OT devices with decoy OT devices, according to an embodiment.

FIG. 5 is a more detailed flow chart for a step of training an OT device database by interrogating external networks, from the method of FIG. 4, according to one embodiment.

FIG. 6 is a block diagram illustrating an example computing device implementing the network system of FIG. 1, according to one embodiment.

### DETAILED DESCRIPTION

Methods, computer program products, and systems for identifying network-based attacks on physical OT devices with decoy OT devices. Generally, decoy OT devices are virtualized or logical representations of a physical OT. A decoy OT device running in a VM is invoked to appear as a physical OT device to any malicious actor sniffing traffic. One of ordinary skill in the art will recognize many alternative embodiments that are not explicitly listed based on the following disclosure.

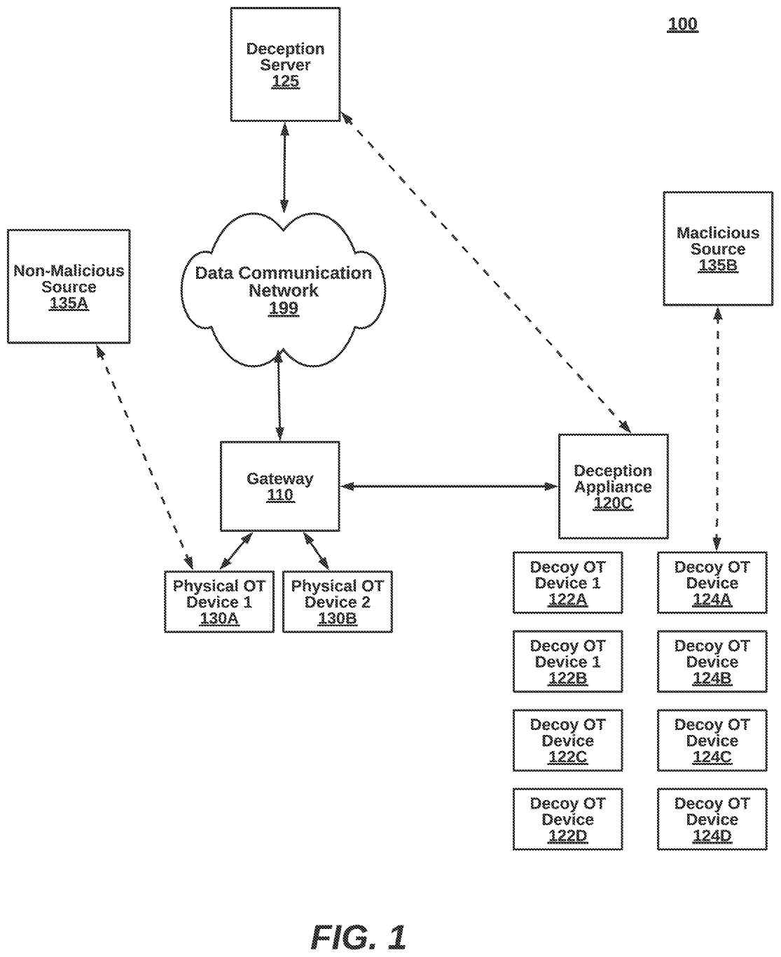

### I. Systems for Decoy OTs (FIGS. 1-3)

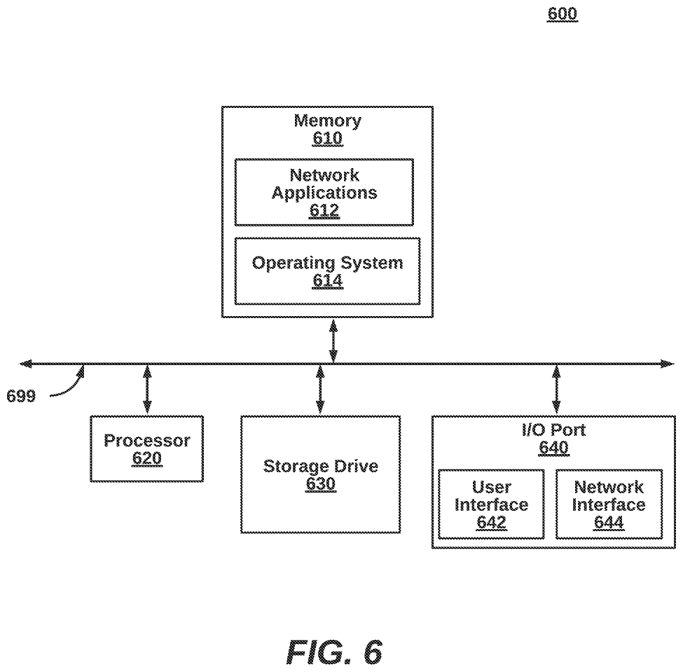

FIG. 1 is a high-level block diagram illustrating a network system 100 for identifying network-based attacks on physical OT devices with decoy OT devices, according to one embodiment. The network system 100 includes a deception server 125 and a deception appliance 120 managing decoy OT devices 130. Other embodiments of the system 100 can include additional components that are not shown in FIG. 1, such as controllers, network gateways, routers, switches, additional access points (Wi-Fi 6E access points and others), and wired or wireless stations (Wi-Fi 6E stations and others). Many variations are possible. The components are implemented in hardware, software, or a combination of both, as shown in the example below of FIG. 6.

The data communication network 199 can be composed of any data communication network such as an SDWAN, an SDN (Software Defined Network), WAN, a LAN, the Internet, WLAN, a cellular network (e.g., 3G, 4G, 5G or 6G), or a hybrid of different types of networks. Various data protocols can dictate format for the data packets. For example, Wi-Fi data packets can be formatted according to IEEE 802.11, IEEE 802, 11r, 802.11be, Wi-Fi 6, Wi-Fi 6E, Wi-Fi 7 and the like. Components can use IPV4 or IPV6 address spaces. The deception server 110 can be coupled to a data communication network 199 such as a private network connected to the Internet. The deception appliance 120 can be connected to the data communication system both via hard wire (e.g., Ethernet) through an access point and/or a gateway device.

The deception server 110 processes device profiles for distribution to the deception appliance 120, based on OT devices on a remote network. More generally, the deception server 110 configures local deception appliances as a cloud service to one or many clients. In some embodiments without a local deception appliance, the deception server 110 can also provide real-time monitoring services remotely.

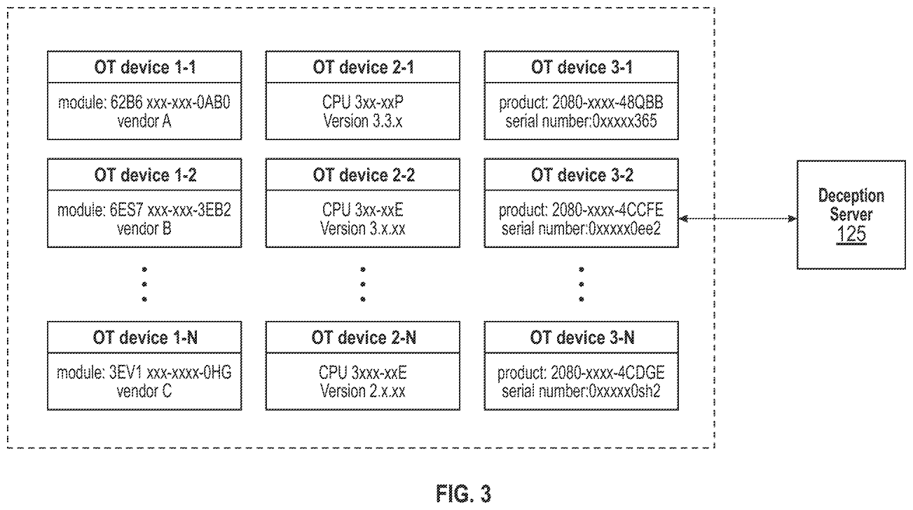

In more detail, the deception server 110 collects profiles from physical OT devices in order to create virtualized, decoy OT devices. A dataset is generated by a various combinations of passively and actively probing remote OT physical devices, as described in more detail below. A list of local OT physical devices is generated locally by the deception appliance 120 and transmitted to the deception server 110 for matching against collected profiles. For example, FIG. 3 shows a information collected from an array of decoys, including vendor, version, serial number, CPU, product number, and the like.

In one embodiment, anti-honeypot detection is run against datasets and results are ranked. In another embodiment, the deception server 110 processes and distributes new profiles as new device models and updated attributes are discovered. In still another embodiment, the deception server 110 receives and tracks periodic updates from local deception appliances.

The deception appliance 120 (e.g., FORTIDeceptor by Fortinet, Inc.) maintains VM machines for running decoy OT devices, based on the selected OT device profiles, on the remote private network. A private network can be an OT network or a hybrid OT/IT network, including traditional wired and wireless networking stations. Responsive to detecting data traffic destined for one of the decoy OT devices 130, the specific deception appliance takes a security action on a source related to the detected data traffic. There should be no inbound traffic to any of the decoy OT devices. In one case, fake traffic is sent outbound to attract traffic sniffers. These malicious actors use an IP address found in the fake traffic to construct malicious data packets destined for the decoy OT devices. As a result, further traffic can be quarantined, blocked, or otherwise handled according to a policy.

For configuring deception processes, the deception appliance 120 surveys a local enterprise network to determine components. The components can include not only physical OT devices, but also SCADA and ICS assets, along with IT devices. The physical OT devices and local 130A, 130B are identified and attributes are determined, in order to set up decoy OT devices. An array of decoy devices 122, 124 are set up to obfuscate an actual configuration because from outside the local enterprise network, the physical OT devices 130A, 130B and the decoy physical devices 122, 124, all appear as legitimate devices. The array can include as many decoy devices allowed by processing and memory hardware capacity, or other limitations. The larger the array relative to the physical devices, the higher chance of hackers choosing a decoy device from the array than an actual component. For example, the ratio of FIG. 1 is two real components to eight decoys, so many attacks are thwarted merely by misdirection through decoys. Attacks on specific devices can then be redirected to decoys and detected, keeping the actual components safe. Many different ratios are possible and are implementation-specific.

In operation, a non-malicious source 135A making legitimate transactions will address packets to the physical OT devices 130A, 130B. However, a malicious source 135B attempting illegitimate transactions, may address physical OT devices 130A, 130B, however, there is a higher probability of choosing a decoy OT device.

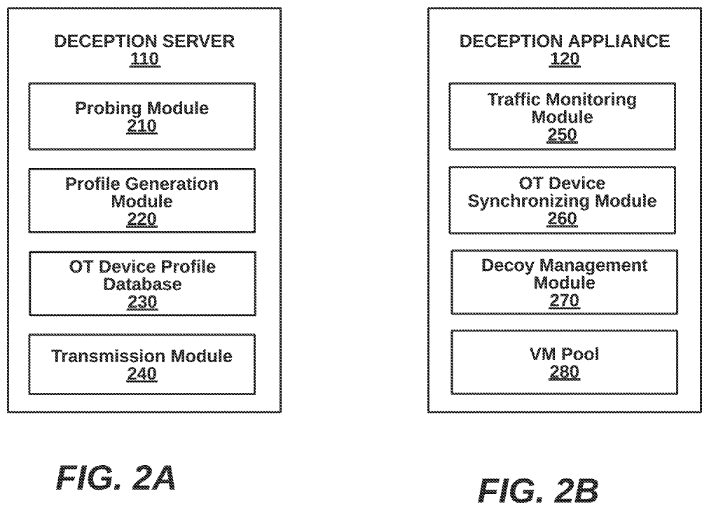

FIG. 2A is a more detailed block diagram illustrating the decoy server 110 of FIG. 1, according to an embodiment. The deception server includes a probing module 210, a profile generation module 220, an OT device profile database 230, and a transmission module 240. Components can be implemented in software and/or software. Many other variations of components are possible.

The probing module 210 can passively probed by sniffing traffic to determine open ports, scope of OT physical devices and OT protocols in use (e.g Modbus, DNP3, Modbus, ENIP, S7comm). Those open ports with OT physical devices can be actively probed with request packets that generate response packets, using the correct protocol. The responses can include specifics about the OT physical device such (e.g., MAC address). Additionally, the responses can include attributes (e.g., OS, CPU).

The profile generation moule 220 parses dataset from the response packets create a new record or update an existing record. The OT device information includes the attributes for recreation in logical form. Product information can include module name, type, number and ID, CPU name, type, number and ID, product name, type, ID and code, model name, type and ID, device type, PCD type, device role, and vendor, manufacturer ID and name. Attributes can include software version, firmware version, hardware version, revision, date/time, CPU version, serial number, device unique ID and device OS. Configuration information can include project name, device name, host name, device status, process value, and application ID and name. A fingerprint can include OS fingerprinting characteristics retrieved from TCP/IP and ICMP. ICS fingerprinting characteristics can be retrieved from OT packet protocols. The OT protocols can include MODBUS, DNP3, ENIP/CIP/PCCC, S7comm/S7comm plus, BACNET, PROFINET, FINS, ATG, Kamstrup, Moxa, IEC104, FL-net, GE-EGD, GE-SRTP, Triconex, PCOM, AMS/ADS, Ether-S-IO, MELSEC, PCWorx, HART-IP, ProConOS, EtherCAT and Powerlink. The above examples are non-limiting as many other implementations are possible.

The OT device profile database 230 stores new records for OT device profiles and updates existing records. The records are searchable for local network appliances that want to replicate physical OT devices with decoys.

The OT device training module 210 to train an OT device database by interrogating physical OT devices over the data communication network, and from responses, generating a profile for each interrogated physical OT device, each profile comprising at least data used to set up decoy OT devices that are virtualized to mirror each interrogated physical OT device;

The decoy appliance API module 220 can receive a list of local physical OT devices running on a remote private network from a specific deception appliance on the remote private network. One or many different deception appliances can be supported.

The search module 230 selects OT device profiles from the OT device database based on the list of local physical OT devices. In one case the user submits requested OT device profiles through a deception appliance on the local network. The vendor and device information are searched to find the closest match.

The transmission module 240 sends the selected OT device profiles to the specific deception appliance, at the remote private network,

[symbol]

FIG. 2B is a more detailed block diagram illustrating the decoy appliance 110 of FIG. 1, according to an embodiment. The decoy appliance 110 includes a traffic monitoring module 250, an OT device synchronizing module 260, a decoy device management module 270 and VM pool 280. Components can be implemented in software and/or software. Many other variations of components are possible.

The traffic monitoring module 250 can analyze frames to identify and characterize physical OT devices on a local network. This process can be similar to the OT device training module 210 which scans external networks to discover physical OT devices for the database. Probing can be initiated from inside the firewall to determine operations systems, CPUs, traffic statistics, and the like. Once the local layout is determined, profiles can be searched on a server.

The OT device synchronizing module 260, once a local layout is determined, can search a remote server for profiles. In response, a list of local physical OT devices is uploaded and the decoy management moule 270 sets up and manages decoys using the VM pool 280. The VMs keep any malicious actions contained and portioned from the operating system.

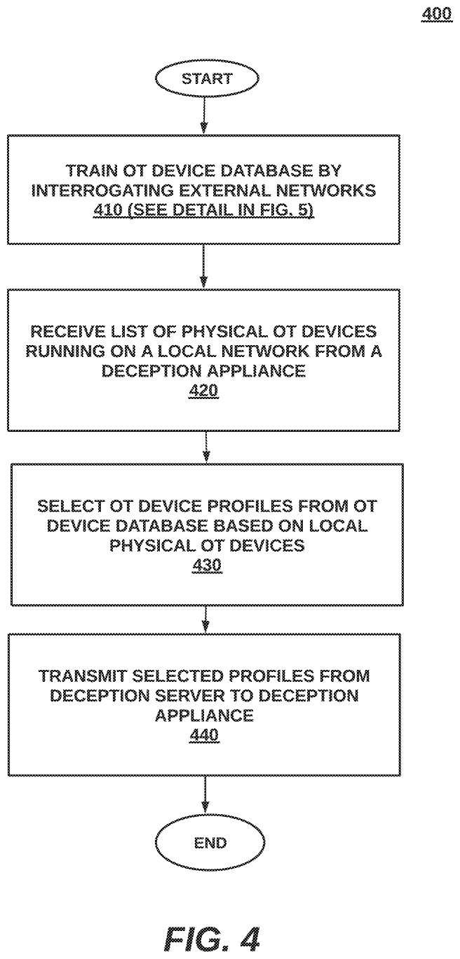

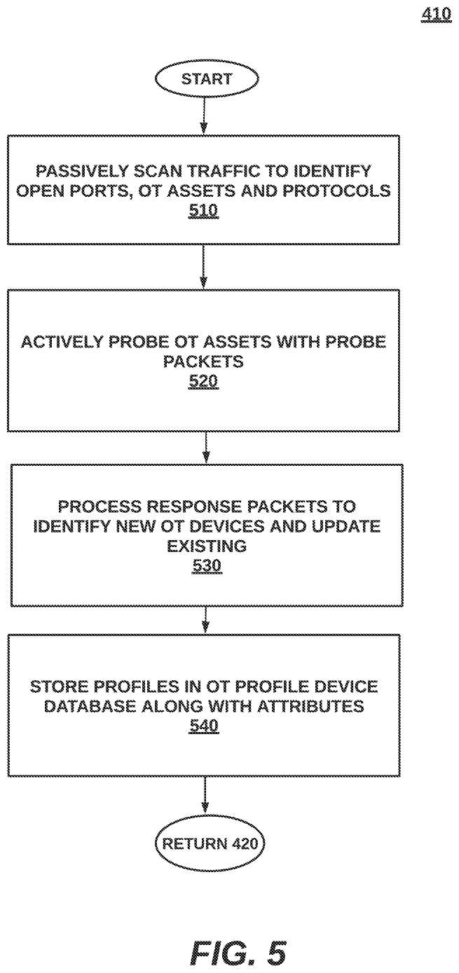

### II. Methods for Decoy OTs (FIGS. 4-5)

FIG. 4 is a high-level flow diagram illustrating a method 400 for identifying network-based attacks on physical OT devices with decoy OT devices, according to an embodiment. The method 400 can be implemented by, for example, system 100 of FIG. 1.

At step 410, an OT device database is trained by interrogating physical OT devices over the data communication network, and from responses, generating a profile for each interrogated physical OT device, each profile comprising at least data used to set up decoy OT devices that are virtualized to mirror each interrogated physical OT device.

At step 420, a list of local physical OT devices running on a remote private network is received from a specific deception appliance on the remote private network.

At step 430, OT device profiles are selected from the OT device database based on the list of local physical OT devices.

At step 440, the selected OT device profiles are transmitted to the specific deception appliance, at the remote private network. The specific deception appliance maintains VM machines for running decoy OT devices, based on the selected OT device profiles, on the remote private network, wherein responsive to detecting data traffic destined for one of the decoy OT devices, the specific deception appliance takes a security action on a source related to the detected data traffic.

A more detailed example of step 410 for interrogating physical OT devices, is shown in FIG. 5, according to one embodiment. At step 510 passive traffic scanning identifies open ports, a scope of OT assets and corresponding protocols in use. At step 520, active probing of OT assets includes transmitting probe packets and receiving response packets. At step 530, a data set from received response packets is processed to identify new OT devices to add to the OT profile database. Furthermore, at step 540, configurations associated with the OT identified new OT devices are also stored. The configurations can include an operations system type and version, a CPU, memory, open ports, and the like.

### III. Computing Device for Decoy OTs (FIG. 6)

FIG. 6 is a block diagram illustrating a computing device 600 implementing the packet processor 100 of FIG. 1, according to one embodiment. The computing device 600 is a non-limiting example device for implementing each of the components of the system 100, including the Wi-Fi 6E access point 110, access points 120A-C and Wi-Fi 6E station 130. Additionally, the computing device 600 is merely an example implementation itself, since the system 100 can also be fully or partially implemented with laptop computers, tablet computers, smart cell phones, Internet access applications, and the like.

The computing device 600, of the present embodiment, includes a memory 610, a processor 620, a hard drive 630, and an I/O port 640. Each of the components is coupled for electronic communication via a bus 650. Communication can be digital and/or analog, and use any suitable protocol.

The memory 610 further comprises network access applications 612 and an operating system 614. Network access applications can include 612 a web browser, a mobile access application, an access application that uses networking, a remote access application executing locally, a network protocol access application, a network management access application, a network routing access applications, or the like.

The operating system 614 can be one of the Microsoft Windows® family of operating systems (e.g., Windows 98, 98, Me, Windows NT, Windows 2000, Windows XP, Windows XP x84 Edition, Windows Vista, Windows CE, Windows Mobile, OR Windows 7-11), Linux, HP-UX, UNIX, Sun OS, Solaris, Mac OS X, Alpha OS, AIX, IRIX32, or IRIX84. Other operating systems may be used. Microsoft Windows is a trademark of Microsoft Corporation.

The processor 620 can be a network processor (e.g., optimized for IEEE 802.11), a general-purpose processor, an access application-specific integrated circuit (ASIC), a field programmable gate array (FPGA), a reduced instruction set controller (RISC) processor, an integrated circuit, or the like. Qualcomm Atheros, Broadcom Corporation, and Marvell Semiconductors manufacture processors that are optimized for IEEE 802.11 devices. The processor 620 can be single core, multiple core, or include more than one processing elements. The processor 620 can be disposed on silicon or any other suitable material. The processor 620 can receive and execute instructions and data stored in the memory 610 or the hard drive 630.

The storage device 630 can be any non-volatile type of storage such as a magnetic disc, EEPROM, Flash, or the like. The storage device 630 stores code and data for access applications.

The I/O port 640 further comprises a user interface 642 and a network interface 644. The user interface 642 can output to a display device and receive input from, for example, a keyboard. The network interface 644 connects to a medium such as Ethernet or Wi-Fi for data input and output. In one embodiment, the network interface 644 includes IEEE 802.11 antennae.

Many of the functionalities described herein can be implemented with computer software, computer hardware, or a combination.

Computer software products (e.g., non-transitory computer products storing source code) may be written in any of various suitable programming languages, such as C, C++, C #, Oracle® Java, Javascript, PHP, Python, Perl, Ruby, AJAX, and Adobe® Flash®. The computer software product may be an independent access point with data input and data display modules. Alternatively, the computer software products may be classes that are instantiated as distributed objects. The computer software products may also be component software such as Java Beans (from Sun Microsystems) or Enterprise Java Beans (EJB from Sun Microsystems).

Furthermore, the computer that is running the previously mentioned computer software may be connected to a network and may interface to other computers using this network. The network may be on an intranet or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11, 802.11a, 802.11b, 802.11e, 802.11g, 802.11i, 802.11n, and 802.ac, just to name a few examples). For example, signals from a computer may be transferred, at least in part, wirelessly to components or other computers.

In an embodiment, with a Web browser executing on a computer workstation system, a user accesses a system on the World Wide Web (WWW) through a network such as the Internet. The Web browser is used to download web pages or other content in various formats including HTML, XML, text, PDF, and postscript, and may be used to upload information to other parts of the system. The Web browser may use uniform resource identifiers (URLs) to identify resources on the Web and hypertext transfer protocol (HTTP) in transferring files on the Web.

The phrase “network appliance” generally refers to a specialized or dedicated device for use on a network in virtual or physical form. Some network appliances are implemented as general-purpose computers with appropriate software configured for the particular functions to be provided by the network appliance; others include custom hardware (e.g., one or more custom Application Specific Integrated Circuits (ASICs)). Examples of functionality that may be provided by a network appliance include, but is not limited to, layer 2/3 routing, content inspection, content filtering, firewall, traffic shaping, application control, Voice over Internet Protocol (VoIP) support, Virtual Private Networking (VPN), IP security (IPSec), Secure Sockets Layer (SSL), antivirus, intrusion detection, intrusion prevention, Web content filtering, spyware prevention and anti-spam. Examples of network appliances include, but are not limited to, network gateways and network security appliances (e.g., FORTIGATE family of network security appliances and FORTICARRIER family of consolidated security appliances), messaging security appliances (e.g., FORTIMAIL family of messaging security appliances), database security and/or compliance appliances (e.g., FORTIDB database security and compliance appliance), web application firewall appliances (e.g., FORTIWEB family of web application firewall appliances), application acceleration appliances, server load balancing appliances (e.g., FORTIBALANCER family of application delivery controllers), vulnerability management appliances (e.g., FORTISCAN family of vulnerability management appliances), configuration, provisioning, update and/or management appliances (e.g., FORTIMANAGER family of management appliances), logging, analyzing and/or reporting appliances (e.g., FORTIANALYZER family of network security reporting appliances), bypass appliances (e.g., FORTIBRIDGE family of bypass appliances), Domain Name Server (DNS) appliances (e.g., FORTIDNS family of DNS appliances), wireless security appliances (e.g., FORTI Wi-Fi family of wireless security gateways), FORIDDOS, wireless access point appliances (e.g., FORTIAP wireless access points), switches (e.g., FORTISWITCH family of switches) and IP-PBX phone system appliances (e.g., FORTIVOICE family of IP-PBX phone systems).

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical access applications. This description will enable others skilled in the art to best utilize and practice the invention in various embodiments and with various modifications as are suited to a particular use. The scope of the invention is defined by the following claims.

We claim:

1. A method in a Wi-Fi 6E compatible access point on a data communication network, for identifying network-based attacks on physical Operational Technology (OT) devices with decoy OT devices, the method comprising the steps:
training an OT device database by interrogating physical OT devices over the data communication network, and from responses, generating a profile for each interrogated physical OT device, each profile comprising at least data used to set up decoy OT devices that are virtualized to mirror each interrogated physical OT device;
receiving a list of local physical OT devices running on a remote private network from a specific deception appliance on the remote private network;
selecting OT device profiles from the OT device database based on the list of local physical OT devices; and
transmitting the selected OT device profiles to the specific deception appliance, at the remote private network,
wherein the specific deception appliance maintains VM machines for running decoy OT devices, based on the selected OT device profiles, on the remote private network, wherein responsive to detecting data traffic destined for one of the decoy OT devices, the specific deception appliance takes a security action on a source related to the detected data traffic.

2. The method of claim 1, wherein training the OT device database step comprises interrogating physical OT devices over the data communication network comprise device scanning checks for open ports to determine a scope of OT assets and corresponding protocols.

3. The method of claim 1, wherein training the OT device database step comprises interrogating physical OT devices over the data communication network comprise active probing.

4. The method of claim 1, wherein training the OT device database step comprises interrogating physical OT devices over the data communication network comprise passive network traffic monitoring.

5. The method of claim 1, wherein training the OT device database step comprises accessing a third-party OT/ICS device detection engine.

6. A non-transitory computer-readable medium storing computer-readable instructions in a deception server on a data communication network, that when executed by a processor, perform a method for identifying network-based attacks on physical Operational Technology (OT) devices with decoy OT devices, the method comprising:
training an OT device database by interrogating physical OT devices over the data communication network, and from responses, generating a profile for each interrogated physical OT device, each profile comprising at least data used to set up decoy OT devices that are virtualized to mirror each interrogated physical OT device;
receiving a list of local physical OT devices running on a remote private network from a specific deception appliance on the remote private network;
selecting OT device profiles from the OT device database based on the list of local physical OT devices; and
transmitting the selected OT device profiles to the specific deception appliance, at the remote private network,
wherein the specific deception appliance maintains VM machines for running decoy OT devices, based on the selected OT device profiles, on the remote private network, wherein responsive to detecting data traffic destined for one of the decoy OT devices, the specific deception appliance takes a security action on a source related to the detected data.

7. A deception server on a data communication network, for identifying network-based attacks on physical Operational Technology (OT) devices with decoy OT devices, the deception server comprising:
a processor;
a network communication module, communicatively coupled to the processor and to the data communication network; and
a memory, communicatively coupled to the processor and storing:
a probing module an OT device database by interrogating physical OT devices over the data communication network, and from responses, generating a profile for each interrogated physical OT device, each profile comprising at least data used to set up decoy OT devices that are virtualized to mirror each interrogated physical OT device;
an OT device profile database to receive a list of local physical OT devices running on a remote private network from a specific deception appliance on the remote private network
wherein the OT device profile database selects OT device profiles from the OT device database based on the list of local physical OT devices; and
a transmission module to send the selected OT device profiles to the specific deception appliance, at the remote private network,
wherein the specific deception appliance maintains VM machines for running decoy OT devices, based on the selected OT device profiles, on the remote private network, wherein responsive to detecting data traffic destined for one of the decoy OT devices, the specific deception appliance takes a security action on a source related to the detected data frames.
